(19) United States
(12) Patent Application Publication
(10) Pub. No.: US 2007/0041141 A1
(43) Pub. Date: Feb. 22, 2007

(54) Over-voltage suppressor and process of preparing over-voltage protection material

(76) Inventor: Sheng-Ming Deng, Hsin Chu (TW)

Correspondence Address: LIN & ASSOCIATES INTELLECTUAL PROPERTY, P.O. BOX 2339, SARATOGA, CA, 95070-0339, US

(21) Appl. No.: 11/208,164

(22) Filed: Aug. 19, 2005

(51) Int. Cl. H02H 9/06

(52) U.S. Cl. 361/118

(57) ABSTRACT

Disclosed are composition and structure of an over-voltage suppressor. One or more non-conductive materials in powder form or non-conductive materials with conductive and/or semiconductor particles are mixed well and then heat-treated to form a nonconductive porous material that is full of non-closed air pores. A film of this porous insulator of controllable thickness is sandwiched between a pair of upper and lower conductor electrodes to form the over-voltage suppressor. This over-voltage suppressor offers the advantages of fast response, low leakage current, low capacitance, easy manufacturing, and high reliability.

### BACKGROUND OF THE INVENTION

1. Field of the Invention

The present invention relates to an over-voltage suppressor structure and a process of preparing over-voltage protection material.

2. The Related Art

Transient high voltages often induce harmful currents and voltages into electronic circuits. Over-voltage suppressors are needed to provide continuous protection in electronic circuits and electrical equipment against transient high voltages.

In recent years, remarkable progress has been made for size reduction and performance improvement in control, communication, and power equipment. But on the other hand, the reliability promotion issues about over-voltage transient protection and EMI/EMC compatibility are not in keeping with the performance improvements of such circuit systems.

The high voltage transient protection devices or over-voltage suppressors act as varistors, and there are two distinct conduction and insulation modes can be identified. There is considerable development in metal oxide varistors due to its high degree of non-linearity as compared with the other devices. Operating in the protective mode, voltage across the varistor is constrained in a narrow range, while the current through the device changes over a range of many orders. Therefore, such non-linear current-voltage characteristics make the device useful in voltage regulation and suppress of high transient voltages.

Solid-state devices or integrated circuits play a primary role in advanced communication system. However, they are susceptible to high voltage transients. There is an increasing demand to develop ceramic composition over-voltage protection devices with controllable threshold voltage, integrable with solid-state devices or integrated circuits that involves the modularization of over-voltage suppressors in integrated circuit designs.

The integrated over-voltage suppressor is often connected across a signal electrode and a ground electrode. When the circuit is in operation situation, the over-voltage suppressor is in insulating mode, the leakage current to the ground is quite small or none, but when the signal electrode experiences a surge, the over-voltage suppressor is switched into a conductor and bypass the surge current to the ground. Thus, the over-voltage suppressor provides continuous surge and transient voltage protection for electronic circuits and electrical equipment.

Metal oxide varistors, such as zinc oxide varistor, are the best known over-voltage protection device made of ceramic composition of zinc oxide and other metal oxide powder additives, such as bismuth oxide, antimony oxide, cobalt oxide, manganese oxide, chromium oxide, nickel oxide, boron oxide, and aluminum oxide to form a zinc oxide varistor.

The metal oxide varistor are generally constructed in various capacitor forms and exhibit high dielectric constant and capacitance. The high capacitance characteristics tend to interrupt or distort high frequency signal, so that this type of over-voltage protection device cannot be applied at high frequency signal path in advanced ISM-band wireless applications.

To solve the above-mentioned problem, U.S. Pat. No. 5,068,634 proposes a different material composition. The conductive powders are dispersed uniformly in insulating base material. In this surge suppresser device, conductive particles are interlaced within thin insulating layers with thickness ranging from 25 to 350 angstroms. If the voltage gets over a threshold voltage, electrons tunnel through the thin insulating layer and breakdown occurs. The threshold voltage or breakdown voltage is determined by the thickness of the insulating layer between conductive particles, and it is hard to control. The over-voltage suppresser may be short-circuited when the insulating gap is too small; on the other hand the threshold voltage may become undesirably high when the gap is large.

There are numerous material compositions of over-voltage suppresser disclosed in for example U.S. Pat. Nos. 3,685,026; 3,685,028; 4,726,991; 4,977,357; 5,260,848; 5,294,374; 5,393,596; and 5,807,509. These known material compositions consist of uniformly mixed semi-conductive powders, metal powders, and binder solution. After certain fabrication procedures, the structure of over-voltage suppresser is comprised of a thin layer of insulator sandwiched between a pair of electrodes and the conductive or semi-conductive powders dispersed in the insulator. The breakdown voltage is controlled by the thickness of the insulating gap between and the conductive or semi-conductive powders, therefore the uniformity of this gap thickness is important for over-voltage suppression application. Over-voltage suppressors with such structures are hard to achieve low transient voltage and poor for power handling.

Still another technique of preparing the over-voltage protection material is to mix powders of glass and materials inherent of PN junctions to resolve these problems. In the final, the porous solid material is full of back-to-back PN junctions, and air pores dispersed over the insulating body. This material composition effectively lowers down the breakdown voltage, and the breakdown voltage can be reduced further if conductor powder is added into the material system. But the device structure of this over-voltage suppresser remains the problem of inefficient power handling capability.

### SUMMARY OF THE INVENTION

The primary objective of the present invention is to provide the device structure and microstructure of an over-voltage suppressor that provides high current rating and high degree of non-linearity in VI characteristics.

The secondary objective of the present invention is to provide an over-voltage protection material that can be easily implemented with precise control of the breakdown voltage without having to resort to precisely control of the thickness of the thin dielectric layer or the density of the semi-conductor particles inherent of PN junctions dispersed therein.

The device structure of the over-voltage suppressor of the present invention is a film of nonconductive porous material, which is full of non-closed air pores sandwiched between a pair of upper and lower conductor. Because the over-voltage suppressor of the present invention is full of interlaced continuous air path embedded within insulating dielectric matrix, so it will exhibit high electrical resistivity and low leakage current under steady low-voltage operation state. As the voltage increases and makes the electric field intensity grow beyond the air's dielectric strength, arcing will occur along the continuous air paths and the voltage is lowed to a safety level.

The present invention provides a process of preparing the over-voltage protection material into paste form by mixing of one or more non-conductive powders, organic solvent and binders and additive conductor powders. Under suitable manufacturing and heat-treating process, a porous insulator full of continuous air path can be formed.

The addition of metal and/or semiconductor powder in the mixed composition can help to reduce the potential barrier across the continuous air path for controlling the breakdown voltage, so that the discharge current is more likely to pass through the space channels of the continuous air path interlaced with conductor powders as shown in FIG. 1(b). As such, the over-voltage protection device enables precise control on the breakdown voltage limit for the electronic and electrical circuits.

The over-voltage suppressor is characterized in that the insulating porous dielectric sandwiched between two electrodes of an electronic circuit offers the advantages of fast response, low leakage current, low capacitance, and high current rating.

The over-voltage protection material is characterized in that the non-conductive materials in powder form used for preparing the porous insulating body can be polymer, ceramic, metal oxide and glass powders.

The over-voltage protection material is characterized in that when the heat-treated material is cooled, non-closed air pores in between the grains through which space discharge is induced at breakdown voltage.

This insulating porous body for over-voltage transient protection across two electrode plates is suitable for many different applications in electronic circuits, as shown in FIGS. 3(a) and 3(b).

The process of forming the over-voltage protection device includes mixing of one or more non-conductive powders, organic solvent and binders and additive of conductor/semiconductor powders, and then treats the mixing materials into paste form. The paste is then deposited on the supporting substrate over two end-separated metal electrodes accompanied with proper heat-treating procedures. Finally a thin porous insulating dielectric full of continuous air paths is formed over the two metal electrodes as shown in FIG. 3(b).

With proper deposition and heat treating procedures, the thin porous dielectric sheet can also be formed between two layers of metal electrodes with overlapping area as shown in FIG. 3(a).

Another process of forming over-voltage protection structure is comprised of shaping and heating the nonconductive porous dielectric into substrate or disc types. And thereafter forming two metal plates as electrode plates on opposite sides of the substrate or disc 400 with overlapping to define the device area as shown in FIG. 3(c).

Still another one uses the multi-layer co-fired ceramic technology, in which the process of forming the over-voltage protection device includes deposition of a thin over-voltage suppresser material sheet over the conductor layer on a ceramic green tape, and deposition of another over-voltage suppresser material sheet over the conductor layer of another ceramic green tape. Stacking the ceramic green tape together in prescribed sequence, and sintering the stacked monolithic ceramic body at high temperature, thus the over-voltage suppressor is embedded into the multi-layer co-fired ceramic package.

These along with other features of novelty that characterize the present invention are pointed out with particularity in the claims annexed to and forming a part of this disclosure. For a better understanding of the present invention, the operating advantages and the specific objectives attained by its uses, references should be made to the accompanying drawings and descriptive matter illustrated in preferred embodiments of the present invention.

### BRIEF DESCRIPTION OF THE DRAWINGS

FIG. 1(a) depicts a microstructure of an over-voltage protection structure for providing continuous over-voltage protection in an electronic circuit in accordance with the present invention;

FIG. 1(b) is another microscopic view of a body full of continuous air paths interlaced with conductor and/or semiconductor powders in another embodiment;

FIG. 2 is a flow chart of the process of preparing the over-voltage protection material in accordance with the present invention;

FIGS. 3(a), 3(b), and 3(c) show the over-voltage suppressors for different circuit designs;

FIGS. 4(a) and 4(b) show more configurations of the over-voltage suppressor; and

FIG. 5 is a characteristic I-V curve in a TLP test showing the non-linear relationship between the current and pulse voltage.

### DETAILED DESCRIPTION OF THE PREFERRED EMBODIMENT

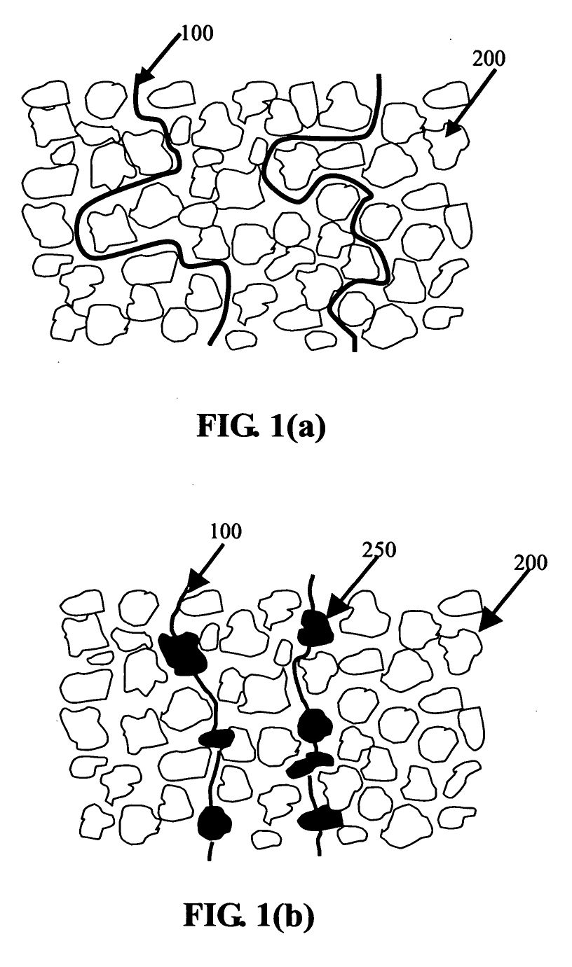

Referring to FIG. 1(a), the microstructure of an insulation body with continuous air paths is composed of non-conductive grains 200. The insulative body is connected across two electrodes and over-voltage protection for electronic circuits is achieved by inducing air discharge at certain breakdown voltage. During cooling, continuous air paths 100 are formed and interlaced in between the grains 200. This over-voltage suppressor offers the advantages of low capacitance, low leakage current, and low breakdown voltage, which makes it suitable for high frequency or wireless communication circuits to eliminate noise, surge and transients.

This closely spaced continuous air paths for over-voltage protection across two electrode plates is suited for many different applications in electronic circuits. Several implementations of the over-voltage suppressor are to be explained through the four embodiments.

### EXAMPLE 1

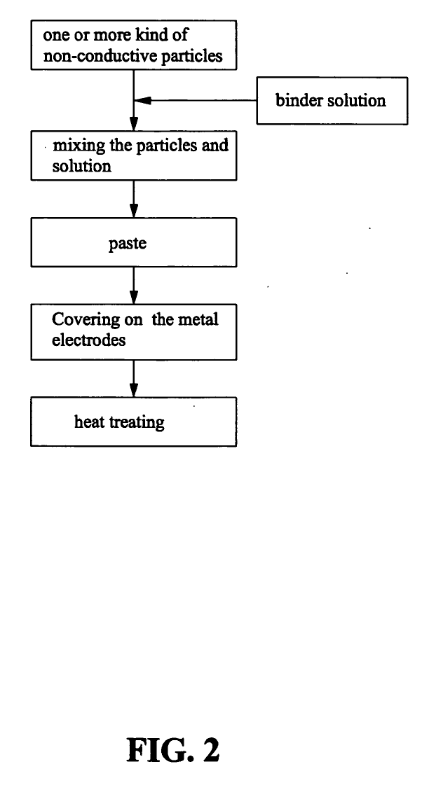

Referring to FIG. 2, the process of preparing the required over-voltage protection material comprises mixing of one or more non-conductive powders 200 (grains) thoroughly in an organic binder solution (using a rotary blender and 3-roller mixer) to form a paste substance, printing the paste onto a supporting substrate to form a desired pattern, filling in the gap between two electrode plates 300 in an electronic circuit, and then heat treating is applied until curing, thus a nonconductive porous body 400 is formed that enables continuous over-voltage protection for an electronic circuit.

The non-conductive grains 200 for making the over-voltage protection material have the resistivity of 10⁸-10¹⁷ Ω-cm under the room temperature (25° C.). The substance suitable for making the non-conductive grains 200 includes polymer, ceramics, metal oxide, and glass powder.

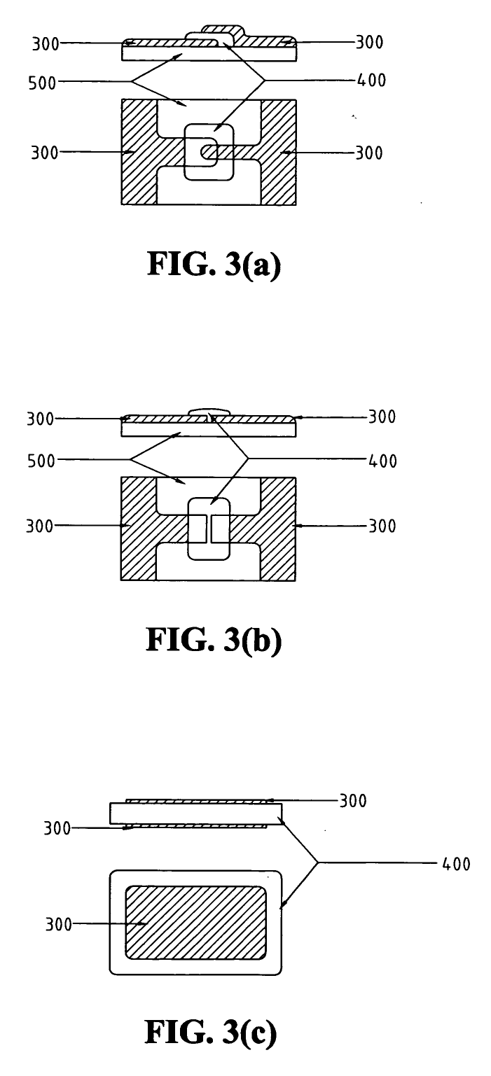

Referring to FIGS. 3(a) and 3(b), the microstructure of the nonconductive porous material is formed by using thick film printing or deposition of thin film over an aluminum oxide substrate 500. The process includes preparation of the required over-voltage protection material paste, forming of a metal electrode 300 over an aluminum oxide substrate 500, forming a layer of over-voltage protection material over the metal electrode 300, and then sintering the circuit board 500 at 500-1100° C. until curing to produce a insulative porous sheet 400 (thickness 3-20 μm), and then creating another layer of metal conductor electrode 300 over on the opposite side of the insulative porous sheet 400.

TABLE ONE

| Composition | Insulator 1 | | Insulator 2 | | Firing Temp (° C.) |
|---|---|---|---|---|---|
| 1 | Al₂O₃(2-3 μm) | 75 wt % | Glass powder 1 (<1 μm) | 25 wt % | 850 |
| 2 | Al₂O₃(4-6 μm) | 70 wt % | Glass powder 1 (<1 μm) | 30 wt % | 800 |
| 3 | Cordierite (2-3 μm) | 75 wt % | Glass powder 1 (<1 μm) | 25 wt % | 850 |
| 4 | — | — | Glass powder 1 (10-25 μm) | 100 wt % | 500 |

TABLE TWO

| | Breakdown | Leakage | Response Time | Capacitance |
|---|---|---|---|---|
| Composition | Voltage (V) | Current (nA) | (nS) | (pF) |
| 1 | 900-1200 | <1 | <1 | <1.8 |
| 2 | 700-900 | <1 | <1 | <1.3 |
| 3 | 850-1000 | <1 | <1 | <1.5 |
| 4 | 800-1400 | <1 | <1 | <1.0 |

The nonconductive porous body 400 of the present invention can be fabricated on a substrate using screen printing, transfer printing, laser printing, or ink jet printing. From Table Two, it can be observed that porous insulator 400 is able to induce space discharge at breakdown voltage through the continuous air paths 100, while controlling the capacitance of the voltage suppressor at low level. When the nonconductive porous body is made using the composition four without the metal oxide, the voltage breakdown range is increased, while the capacitance is decreased.

### EXAMPLE 2

The process of preparing the required over-voltage protection material comprises adding of 500 ppm Pt active point site to Al₂O₃ to produce Al₂O₃—Pt, mixing the non-conductive powder 200 (grains) of Al₂O₃—Pt in organic binder solution (using a rotary blender and 3-roller mixer) to form a paste, depositing the paste in between the two metal electrodes, firing to form continuous-pore, insulative body 400, where the deposition of insulative film can be done by thick film printing or thin film deposition.

From Table Four, it can be observed that the insulative dielectric can be made to different thickness so as to control the breakdown voltage limits for different types of over-voltage suppressors. If the thickness of the insulative dielectric 400 is increased, the voltage for triggering space discharge is also increased. When the voltage-controllable resistive bodies 400 with composition one and composition five are compared, it is clear that the addition of Pt active point sites to Al₂O₃ can help lower the breakdown voltage for inducing space discharge.

TABLE THREE

| | Insulator 1 | Insulator 2 | Firing Temp | | Thickness |
|---|---|---|---|---|---|
| Composition | (2-3 μm) 75 wt % | (<1 μm) 25 wt % | (° C.) | Structure | (μm) |
| 5 | Al₂O₃—Pt | Glass powder 1 | 850 | FIG. 3(a) | 10-15 |
| 6 | Al₂O₃ | Glass powder 1 | 850 | FIG. 3(b) | 10-15 |
| 7 | Al₂O₃ | Glass powder 1 | 850 | FIG. 3(c) | 300-350 |

*G1 = glass powder 1

TABLE FOUR

| | Breakdown | Leakage | Response Time | Capacitance |
|---|---|---|---|---|
| Composition | Voltage (V) | Current (nA) | (nS) | (pF) |
| 5 | 450-650 | <1 | <1 | <1.2 |
| 6 | 800-1000 | <1 | <1 | <1.0 |
| 7 | 2200-2500 | <4 | <1 | <5 |

### EXAMPLE 3

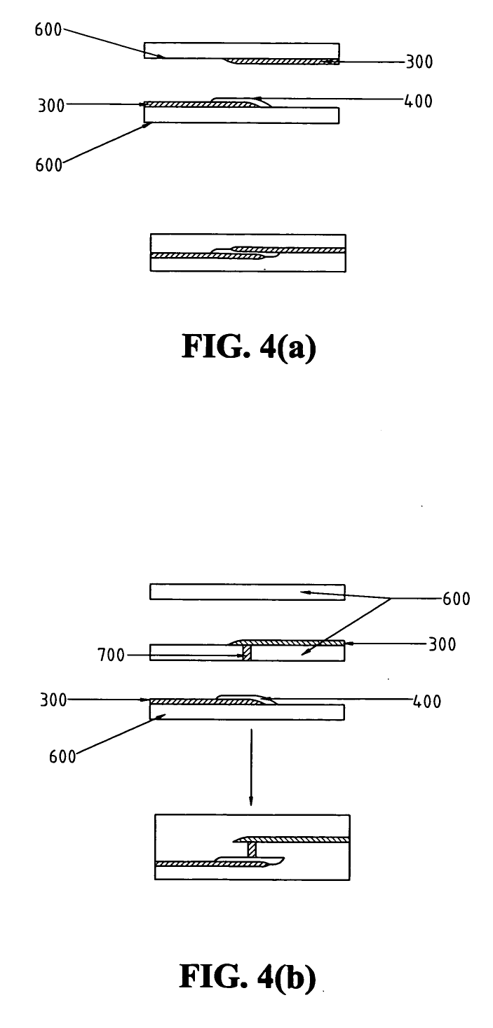

Referring to FIGS. 4(a) and 4(b), this embodiment employs the multi-layer co-fired ceramic technology and the composition one to produce the over-voltage suppressor. The fabrication process includes the forming of a metal electrode layer 300 on the ceramic tape 600 using thick film printing or thin film deposition, covering the metal electrode layer 300 with a layer of over-voltage-suppression paste 400, forming another metal electrode layer 300 on another ceramic tape 600.

The two separately processed ceramic tapes are then stacked together to form a monolithic ceramic substrate embedded with voltage suppressor. They can be stacked in a form that the electrodes and suppressor at the same interface, as shown in FIG. 4(a), or in another form that the two electrodes are in different layers and electrical conduction path is formed by a conductive through hole, as shown in FIG. 4(b).

The metal electrode layers 300 overlap each other in certain area, one end of which is connected to ground, and the other end is connected to other circuits or components. The over-voltage suppression body 400 having continuous air paths 100 is placed between the metal electrode layers 300. The ceramic tapes 600 are then stacked in a prescribed sequence, and then the stacked ceramic body 600 are sintered at high temperature (over 800° C.) to form a multi-layer co-fired ceramic over-voltage suppressor.

This multi-layer co-fired over-voltage suppressor of the present invention demonstrates superior performance in breakdown voltages, leakage current, response time, and capacitance as shown in Table Five.

TABLE FIVE

| Composition/ | Breakdown | Leakage | Response | Capacitance |
|---|---|---|---|---|
| Structure | Voltage (V) | Current (nA) | Time (nS) | (pF) |
| FIG. 4 (a) | 850-1000 | <1 | <1 | <2.1 |
| FIG. 4 (b) | 800-1000 | <1 | <1 | <1.4 |

### EXAMPLE 4

Referring to FIG. 1(b), the process of preparing the required over-voltage protection material comprises adding Pt particles or Pt and silicon carbide particles 250 to non-conductive grains 200 (G1 or Al₂O₃ and G1), mixing theses powders 200 and 250 (grains) in an organic binder solution (using a rotary blender and 3-roller mixer) to form a paste, printing the paste over the metal electrodes 300 to form a nonconductive porous material 400, (or first creating a disc structure 400 and then forming two metal electrodes 300 on opposite sides of the polycrystalline disc 400), and then heat treating the raw device until curing, thus a continuous-pore, insulative body 400 is formed across two metal electrodes 300.

Comparing the voltage suppressor of composition eight and nine with that of composition one, it can be observed that the insulative voltage-suppression body 400 formed with additive Pt particles can lower the breakdown voltage. The size of the Pt particles shall be in the range 0.005 μm-100 μm, and it content is under 40 wt %. And by comparing the voltage suppressor of composition ten with that of composition eight, it can be observed that the insulative voltage-suppression body 400 formed with additive silicon carbide particles instead of Al₂O₃ particles can lower the breakdown voltage further more. The size of the silicon carbide particles is in the range between 0.05 μm-100 μm.

TABLE SIX

| | Insulator 1 | Insulator 2 | Metal powder | Firing Temp | | Thickness |
|---|---|---|---|---|---|---|
| Composition | (2-3 μm) | (<1 μm) | (<1 μm) | (° C.) | Structure | (μm) |
| 8 | Al₂O₃ 68 wt % | G1 23 wt % | Pt 9 wt % | 850 | FIG. 3(a) | 10-15 |
| 9 | Al₂O₃ 62 wt % | G1 20 wt % | Pt 18 wt % | 850 | FIG. 3(a) | 10-15 |
| 10 | SiC 66 wt % | G1 25 wt % | Pt 9 wt % | 850 | FIG. 3(a) | 10-15 |

*G1 = glass powder 1

TABLE SEVEN

| | Breakdown | Leakage | Response Time | Capacitance |
|---|---|---|---|---|
| Composition | Voltage (V) | Current (nA) | (nS) | (pF) |
| 8 | 500-700 | <1 | <1 | <1.2 |
| 9 | 250-400 | <1 | <1 | <1.0 |
| 10 | 350-500 | <1 | <1 | <1.5 |

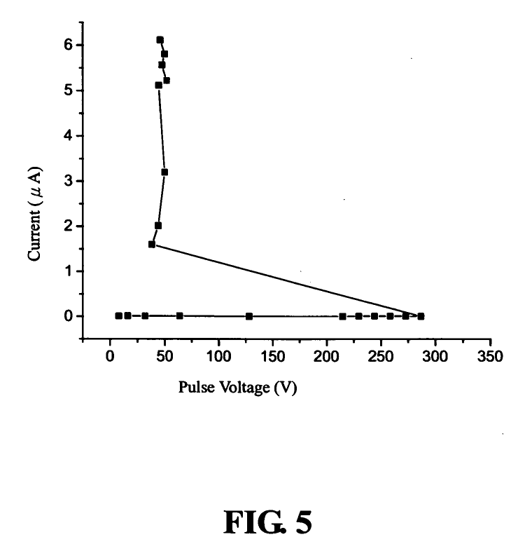

From FIG. 5, the performance curve obtained from the TLP test of the over-voltage suppressor shows that the continuous air path 100 become conductive as the pulse voltage reaches over 250V.

When the circuit is in operation, the voltage suppressor body 400 is initially in high resistance, the leakage current to the ground is quite small or none, but when high voltage pulses pass through, the suppressor body 400 is switched to low resistance state to allow the surge current to be channeled to ground through the ground electrode. This also demonstrates the high current rating and high degree of non-linearity in VI characteristics offered by the over-voltage suppressor of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A process of preparing over-voltage protection material, comprising the steps of: mixing of one or more non-conductive grains in powder form, and fabricating the over-voltage suppresser onto supporting substrate, and then heat treating the row device until curing to form insulative body having interlaced continuous air paths.

2. The process of preparing over-voltage protection material as claimed in claim 1, wherein the non-conductive grains have the resistivity of 10⁸-10¹⁷ Ω-cm under room temperature (25° C.).

3. The process of preparing over-voltage protection material as claimed in claim 1, wherein the non-conductive grains can be made from polymer, ceramic, metal oxide and glass powder materials.

4. The process of preparing over-voltage protection material as claimed in claim 1, wherein in the fabrication process, one or more kinds of metal powder and semiconductor powder are added including gold, silver, platinum, palladium, ruthenium, aluminum, copper, nickel, iron, zinc, lead, tin, tungsten, molybdenum, titanium, chromium, and silicon carbide.

5. The process of preparing over-voltage protection material as claimed in claim 1, wherein in the fabrication process, the metal powders and semiconductor powders are powders with diameter 0.005 μm-100 μm.

6. An over-voltage suppressor, comprising:
A pair of metal electrodes, where one end is connected to ground, and the other end is connected to other circuits or components to form electrical connection; and
an insulative porous body having continuous interlaced air path to be deposited between the two metal electrodes.

7. The over-voltage suppressor as claimed in claim 6, wherein the metal electrode can be formed from one or more kinds of ingredients including gold, silver, platinum, palladium, ruthenium, aluminum, copper, nickel, iron, zinc, lead, tin, tungsten, molybdenum, titanium, and chromium.

8. The over-voltage suppressor as claimed in claim 6, wherein the insulative porous body is formed by mixing one or more kinds of non-conductive grains thoroughly in binder solution.

9. The over-voltage suppressor as claimed in claim 8, wherein the non-conductive grains having the resistivity range 10⁸-10¹⁷ Ω-cm in room temperature (25° C.).

10. The over-voltage suppressor as claimed in claim 8, wherein the non-conductive grains is made from substances including polymer, ceramics, metal oxide, and glass powder.

11. The over-voltage suppressor as claimed in claim 8, wherein one or more kinds of metal powder and semiconductor powder are added, including gold, silver, platinum, palladium, ruthenium, aluminum, copper, nickel, iron, zinc, lead, tin, tungsten, molybdenum, titanium, chromium, and silicon carbide.

12. The over-voltage suppressor as claimed in claim 8, wherein the metal powders and semiconductor powders are powders with diameter 0.005 μm-100 μm.
